(19) United States
(12) Patent Application Publication
(10) Pub. No.: US 2009/0316013 A1
(43) Pub. Date: Dec. 24, 2009

(54) System and method for processing medical graphics data

(76) Inventors: Jana C. Largent, Pearland, TX (US); Sue C. Vindett, Pearland, TX (US); Randy Ray Roofner, Rosharon, TX (US); William A. Sinacori, Pearland, TX (US)

Correspondence Address: Hugh R. Kress;Browning Bushman P.C., 5718 Westheimer, Suite 1800, Houston, TX, 77057--577, US

(21) Appl. No.: 12/214,712

(22) Filed: Jun. 20, 2008

(51) Int. Cl. H04N 5/228

(52) U.S. Cl. 348/222.1; 348/E05.001

(57) ABSTRACT

A medical imaging device system is provided which obviates the need for certain costly components conventionally found in such systems. In a disclosed embodiment, a direct video output from one or more imaging devices is provided to a video capture unit, rather than having the output processed by a conventional DICOM methodology. In this way, the necessity of PACS server functionality and corresponding implementation and maintenance of such a server is obviated. The capture video is annotated and supplemented by a user and the resulting records are stored in a shareable central repository.

### FIELD OF THE INVENTION

The present invention relates generally to digital images, and more particularly to the acquisition, storage, and processing of medical images.

### BACKGROUND OF THE INVENTION

The introduction of digital medical image sources in the 1970's and the use of computers in processing these images after their acquisition, led the medical community to recognize the desirability of establishing some degree of uniformity in the processes used for acquisition, communication, storage, and processing of the underlying digital data. The American College of Radiology (ACR) and the National Electrical Manufacturers Association (NEMA) joined forces to establish a committee whose intended purpose was to create a standard method for the transmission of medical images and their associated information. This committee, formed in 1983, published in 1985 the ACR-NEMA Standards Publication No. 300-1985.

Prior to 1985, most medical imaging devices stored image data in a proprietary format and transferred files of these proprietary formats over a network or on portable media in order to perform image communication. While the initial version of the ACR-NEMA effort (version 2.0 was published in 1988) created some standardized terminology, an information structure, and unsanctioned file encoding, most of the promise of a standard method of communicating digital image information was not realized, even following the release of version 3.0 of the ACR-NEMA Standard in 1993.

The release of version 3.0 of the ACR-NEMA standard saw a name change, to Digital Imaging and Communications in Medicine (DICOM), and included numerous enhancements that purported to deliver on the promise of standardization in the area of medical digital imaging. Presently, DICOM is a standards organization administered by NEMA Diagnostic Imaging and Therapy Systems Division. The organization is comprised of over two dozen of “working groups,” each with its own leadership, and short-term and long-term objectives. (See “DICOM Strategic Document,” Version 7.1, Mar. 29, 2007) (“DICOM Strategic Document”).

The DICOM standard specifies a network protocol utilizing TCP/IP, defines the operation of “Service Classes” beyond the simple transfer of data, and creates a mechanism for uniquely identifying “Information Objects” as they are acted upon across a network. Just as the DICOM organization consists of numerous separate “working groups,” the DICOM standard itself is structured as a multi-part document in order to facilitate “extensions” of the standard.

DICOM is widely used in the medical field as a protocol for transmission of medical images. Beside pixel value data, various kinds of information, such as patient information and information concerning the image display, accompanies a file as a header, as would be understood by those of ordinary skill. Since the DICOM standard supports the TCP/IP protocol of the current Internet, the use of the DICOM standard theoretically permits apparatuses made by different manufacturers to transfer and exchange information on patients and/or medical image data by way of a network.

Despite the stated aspirations of the DICOM standards organization to achieve interoperability among different vendors' medical imaging systems and platforms, there is a widespread understanding among those of ordinary skill in the art that as a practical matter, this lofty goal has not been fully achieved. While it may be true that “[e]very major diagnostic medical imaging vendor in the world has incorporated the standard into its product design,” (See DICOM Strategic Document, p. 2), the DICOM standards organization recognizes that this does not necessarily mean that true cross-vendor interoperability has been achieved among the numerous medical professions that utilize medical images, or among the countless vendors offering hardware and software relating to the creation, handling, processing, and storage of medical image data. Indeed, the DICOM organization itself states that “[t]he co-operation of DICOM with other standards is becoming an increasingly important point in the endeavor to achieve the overall electronic medical record for the patient . . . the maturity of such standards . . . and the lack of consensus on which standards to use, makes this a complex process, on which DICOM has little influence.” See, DICOM Strategic Document, page 17.

At present, therefore, no meaningful degree of cross-vendor interoperability has been shown in “real world” applications. A multitude of vendors put forth “DICOM Compliance Statements” purporting to show the extent of adherence to DICOM each vendor as maintained, such statements are typically replete with disclaimers of any true degree of cross-vendor interoperability. As but one example, one vendor's “DICOM Conformance Statement” notes that it “by itself does not guarantee successful interoperability of [vendor's] equipment with [non-vendor] equipment.”

Moreover, the DICOM standard has been constantly evolving and adapting to new technologies and new functional requirements for over two-and-a-half decades. Thus, compliance with DICOM is, as a practical matter, not realistically achievable.

The cross-vendor incompatibility of medical imaging systems, even within a single medical specialty, such as sonography, is abundantly evident. More critically, such incompatibilities lead to considerable costs (in terms of both dollars and man-hours) for end-users. A medical imaging facility must purchase and maintain the hardware and software necessary to provide DICOM-encoded graphics data, separately for each brand or type of imaging device.

To make matters even worse, DICOM is not the “end of the line” as far as medical imaging infrastructures are concerned. Typically, each vendor or system will have its own or a recommended Picture Archiving and Communications System (PACS), whose function it is to act as an intermediary between medical imaging data (i.e., the end-product of a DICOM based system) and the various entities that must have access to the image data, such as, for example, physician workstations at which clinicians review and annotate graphics data files.

PACS has become an increasingly important component in the management of digitized image data, particularly in the field of medical imaging. Such systems often function as central repositories of image data, receiving the data from various sources, such as medical imaging systems. The image data (which is customarily in the DICOM format) is stored and made available to clinicians via network links. Improvements in PACS have led to dramatic advances in the volumes of image data available and have facilitated loading and transferring of voluminous data files both within institutions and between central storage locations and remote clients.

To illustrate, FIG. 1 is a highly simplified functional diagram of a hypothetical system 10 incorporating a plurality of imaging devices 12-1 . . . 12-n. For the sake of the illustration in FIG. 1, it is assumed that each imaging device 12-x is manufactured by a different vendor. As a result of the typical incompatibility among different vendors' DICOM “compliant” systems, the raw image data produced by the imaging device must be processed by a given vendor's DICOM system, represented by blocks 14-1 . . . 14-n in FIG. 1. (Although the DICOM systems 14-x in FIG. 1 are shown as discrete entities, it is often the case that the DICOM functionality—translation of imaging data into the DICOM format—is performed internally Within the imaging devices themselves.)

With continued reference to FIG. 1, the DICOM formatted data from the imaging devices 12-x are communicated to a PACS server 16. Those of ordinary skill in the art will appreciate that this communication of data from imaging devices 12-x to PACS server 16 necessarily requires that the PACS server 16 must provide DICOM compatibility separately for each imaging device 12. This is represented by the separate DICOM blocks 15-1, 15-2, . . . 15-n on the PACS server side each corresponding to DICOM blocks 14-1, 14-2, . . . 14-n on the imaging device side.

A simplistic analogy would be the necessity of ensuring that on a typical home computer, the computer has the hardware and software installed that enables it to communicate properly with a given peripheral device, such as a printer. Those of ordinary skill in the art will be familiar with situations in which an operating system (such as any given flavor of Microsoft® Windows®) will alert the user to the need for installation of a driver whenever a new peripheral, such as a printer, mass storage device, etc.) is detected by the operating system. Such a driver enables the computer and the printer to communicate in the same “dialect” in order to cooperatively function.

In the case of DICOM and PACS, a similar situation exists, but on a much costlier level. Although DICOM is intended to bring some uniformity to the formatting of medical graphic data, it is nevertheless necessary, on a lower level, to ensure that the PACS server 16 is properly configured to receive such data from a given imaging device. In general, medical graphic imaging devices are highly sophisticated and complex systems, typically requiring a vendor-specific technician to be involved in the configuration and maintenance of communication between the device and a PACS server. Moreover, the vendor-specific technician on the imaging device side may be relatively unfamiliar with the particular implementation of the PACS server, thereby requiring in many cases, the involvement of a separate technician to fully integrate the medical device with the PACS server.

In practical terms, the aforementioned technical requirements are often only met by requiring the operator of the overall system (e.g., a hospital or clinic) to (1) purchase or license the particular software necessary for both the DICOM side and the PACS server side; and (2) to enter into sometimes long-term maintenance agreements with the medical device vendor and the PACS server vendor in order to ensure proper initial configuration and ongoing reliable operating of the system.

In the aggregate, procurement of an imaging device (and its associated DICOM encoder), a PACS server, and the licensing and maintenance of necessary software to ensure interoperability of the systems can be quite costly for the operator. For example a new sonogram machine may cost in the $40 k to $100 k range; costs for hardware, software, storage for archiving, support and maintenance, and setup with the highest level of fault tolerance for a large facility could easily end up in the $1-3 million range. Smaller facility setups may be less expensive, for example, on the order of $75,000 to $500,000, depending on storage for archiving, fault tolerance scenarios, and support and maintenance intervals. These up-front costs do not include substantial yearly maintenance and service agreements to ensure ongoing reliable operation, maintenance, and updating of the underlying software components,

Part of the functionality of a PACS server 16 is to provide facilities (including appropriate user interfaces such as displays, keyboards, cursor control devices and the like, as would be well understood by those of ordinary skill in the art) to enable a clinician or technician to annotate data stored on the PACS server, and/or further to incorporate the DICOM-formatted data into predetermined templates containing image-specific notations and the like, which can be subsequently accessed by appropriate personnel. This need is reflected by including in system 10 at least one physician workstation 22 by which clinicians can organize graphics data through application of predefined templates 23. The resulting annotated data can be viewed on a monitor 20 associated with a workstation 22. Upon application of templates and appropriate annotation of the graphics data, final reports can be generated as represented by functional block 30 in FIG. 1. The final reports can be stored in a central storage repository 32, such that the reports, including the graphics data, can be accessed by other physician stations (not shown).

It is to be noted that the communication of graphics data from PACS server 16 to a physician workstation 22 involves yet another instantiation of DICOM, as represented by blocks 34 and 36 in FIG. 1. These DICOM blocks may be specific to the PACS server 16 and/or workstation 22, further increasing the complexity of the overall system and as a consequence, increasing the costs associated with setting up and maintaining the system 10.

It is to be noted that care must be taken and expenses possibly incurred to ensure that the DICOM formatted data from PACS server 16 is compatible with the physician workstation at which annotations are made and templates are applied. This undesirable requirement is represented by DICOM X blocks 34 and 36 in FIG. 1. It is typically desirable to provide facilities for backup or secondary storage of the data stored by the PACS server, as represented by block 32 in FIG. 1. Those of ordinary skill in the art will appreciate that as imaging technology advances, the sheer size of medical graphics is becoming ever greater, making it less and less feasible for all of a given enterprises data to be stored only on the PACS server 16. The PACS server must also support a means for presentation of PACS data to users (e.g., physicians) for interpretation and review. It is to be noted that physician interpretation and annotation (block 22) can involve additional editing, and annotation of the PACs data, before a final report (block 30) is generated.

### SUMMARY OF THE INVENTION

In view of the foregoing, the present invention is directed to a system and method for processing graphics data, such as medical graphic imaging, in a manner which obviates the necessity of implementing proprietary protocols in order to process, store, and retrieve the graphics data.

In accordance with one aspect of the invention, the system takes advantage of a raw video output signal from graphical imaging devices, such as sonographic imaging devices. A video capture component captures still images and/or segments of real-time video. The system maintains the captured data in a standardized template, and provides the operator the ability to review and annotate the data.

In accordance with another aspect of the invention, graphical imaging data is stored in a central repository such that it is accessible to those persons having a need to review and analyze the data. The data templates can be communicated to remote users via a encrypted and invitation only computer network (including, but not limited to the Internet).

### BRIEF DESCRIPTION OF THE DRAWINGS

The foregoing and other features and aspects of the present invention will be best appreciated by reference to a detailed description of the specific embodiments of the invention, when read in conjunction with the accompanying drawings, wherein:

FIG. 1 is a simplified functional block diagram of a prior art graphical imaging system;

FIG. 2 is a simplified functional block diagram of a graphical imaging system in accordance with one embodiment of the invention; and

FIG. 3 is a depiction of a graphical user interface presented to the operator of the system of FIG. 2.

### DETAILED DESCRIPTION OF SPECIFIC EMBODIMENTS OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such a development effort might be complex and time-consuming, but would nevertheless be a routine undertaking for those of ordinary skill in the relevant fields.

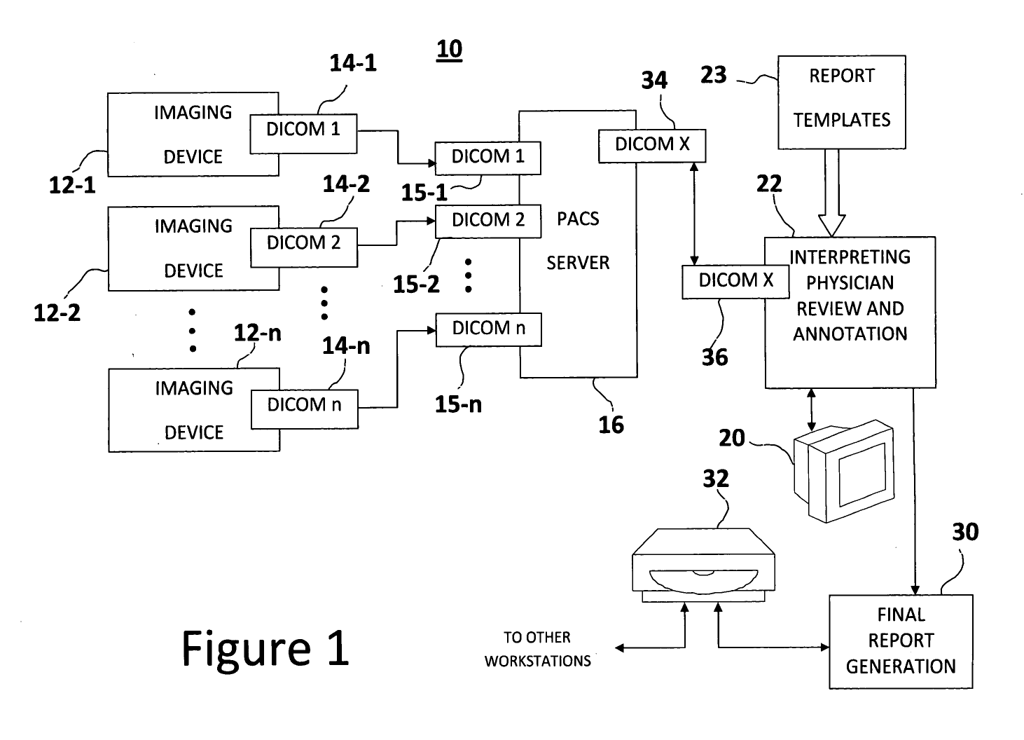

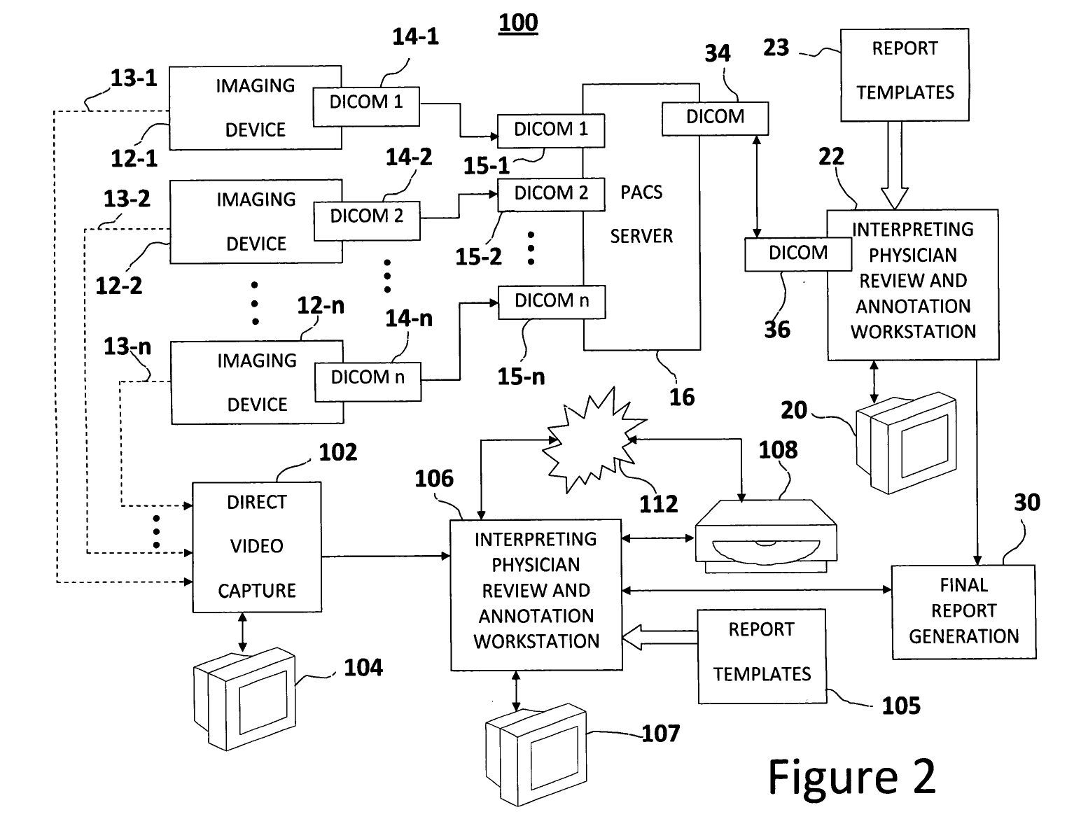

Referring to FIG. 2, there is shown a functional block diagram of an imaging device system 100 utilizing features and methodologies of the present invention. It is to be noted that components of system 100 in FIG. 2 that are substantially identical to those of FIG. 1 retain the same reference numerals.

In accordance with one aspect of the invention, it is to be noted in FIG. 2 that separate video outputs 13-1, 13-2, . . . 13-n are provided by each imaging device 12. These separate outputs correspond to the standard “S-video”, BNC cable, or RCA type analog raw video outputs that exist on most if not all state-of-the art imaging systems, such as sonogram equipment. In accordance with one aspect of the invention, these raw video outputs 13-1 . . . 13-n are not customarily used for any purpose other than to display graphics images during the imaging process, such as for example on a monitor disposed in an examination room allowing the patient to observe the imaging process.

Those of ordinary skill in the art will be familiar with instruments and devices having an S-video and/or BNC cable inputs and/or outputs. S-video refers to “super video,” a technology for transmitting video signals over a cable by dividing the video information into two separate signals: one for color (chrominance), and the other for brightness (luminance). When sent to a television or monitor, S-video produces sharper images than composite video, where the video information is transmitted as a single signal over one wire. This is because conventional televisions are designed to display separate Luminance (Y) and Chrominance (C) signals. (The terms Y/C video and S-video are the same.) To use S-Video, the device generating the video signal must support S-video output and the device receiving the signals must have an S-video input jack. A standard S-video cable connects the two devices. For the purposes of the present disclosure, it is to be understood that an S-video signal corresponds to a raw, unprocessed, and unencoded video signal.

The BNC (bayonet) connector is used for RF signal connections, both for analog and Serial Digital Interface video signals, amateur radio antenna connections, aviation electronics (avionics) and on nearly every piece of electronic test equipment manufactured in the last 35 or so years. This connector is an alternative to the RCA connector when used for composite video on commercial video devices, however many consumer electronics with RCA jacks can be used with BNC-only commercial video equipment via a simple adaptor. BNC connectors were commonly used on thin Ethernet networks, both on cable interconnections and network cards. To use BNC, the device generating the video signal must support BNC output and the device receiving the signals must have a BNC input jack. A standard BNC cable connects the two devices. For the purposes of the present disclosure, it is to be understood that a BNC signal corresponds to a raw, unprocessed, and unencoded video signal.

It is to be specifically noted that although the present invention takes advantage of an imaging device video output that is not utilized in conventional graphical imaging systems, since this output is already present on a most if not all of state-of-the-art imaging equipment, the present invention advantageously requires no modification whatsoever to existing equipment, making the present invention practical and beneficial even to existing systems.

With continued reference to FIG. 2, the S-video and/or BNC outputs are supplied to a direct video capture unit 102. In the presently disclosed embodiment of the invention, video capture unit 102 is implemented in the form of a conventional computer, such as desktop or server computers that are commonly present in business or clinical workspaces. In a preferred embodiment, the computer serving as the direct video capture component of the system is equipped with a multi-port video capture expansion card (although a stand-alone video capture unit may be utilized in connection with a computer). There are countless makes and models of video capture cards and equipment commercially available, and the selection of one make and model over another is not believed to be critical to the subject matter of the present disclosure.

When implemented on a computer platform as described herein, the system 100 enables a user to provide annotations to be associated with the captured video, as represented by workstation block 106 in FIG. 2. Individual captured images or segments of video (also referred to as “cineloops”) may be annotated with identifying information of all kinds, and these data elements (graphics files, annotation files, etc.) may be incorporated into predetermined templates, as represented by block 105, which bring all of the elements together into a single file or record. Templates 105 may be supplied to achieve uniformity in the final reports generated at block 30.

Once a given template has been created an populated with the necessary components (video clips, video stills, annotations and other identifying information, etc.), this collective record is transferred to a mass storage device or data repository 108 containing a plurality of folders, with each folder corresponding, for example, to a given patient.

From FIG. 2, it is apparent that the transfer of the records occurs via a link 112. It is contemplated that this link 112 may represent any means by which computer data is transferred from one place to another. For example, records may be transferred to repository 108 via a direct (hardwired) link, via a network, via the internet, or via physical transfer of portable storage media, such as a CD or DVD, from one location to another remote location. In a preferred embodiment, connection 112 comprises some combination of a local area network, a wide area network, and the Internet, as would be appreciated by those of ordinary skill.

In the presently preferred embodiment, it is contemplated that the repository 108 may be established and maintained by a single service provider serving a plurality of clinics or hospitals, thereby reducing the burden on clinical facilities to store and maintain the data. This central facility may provide additional services, such as providing for secure backup and retrieval facilities. This is especially advantageous due to the typically large file size associated with graphics file records and the critical importance of insuring the privacy and integrity of the data at all times.

In accordance with one aspect of the invention, files in storage repository 108 are organized into a “file folder” structure that would be familiar to anyone of ordinary skill in the art. (The structure is analogous to the file storage hierarchy found in Microsoft® Windows® operating environments).

Preferably, file repository 108 is connected to the Internet (reference numeral 112 in FIG. 2) such that files in repository 108 may be shared by authorized users at remote locations. Again, the concept of shareable files (and the associated security and protection mechanisms associated therewith) would be familiar to anyone of ordinary skill in the art and/or anyone familiar with the file storage hierarchy found in Microsoft® Windows® operating environments.

One example of a remote user who might be granted access to files in repository 108 is a physician workstation such as workstation 106 shown in FIG. 2. Note that this is the same type of workstation as that which might be used and hence already present in a prior art system.

As described herein, several advantages of the invention will be apparent to those of ordinary skill in the art. Perhaps most notable is the feature that the present invention entirely avoids the use of DICOM and PACS equipment and functionality, and thereby significantly reduces the costs associated with the overall medical graphics system.

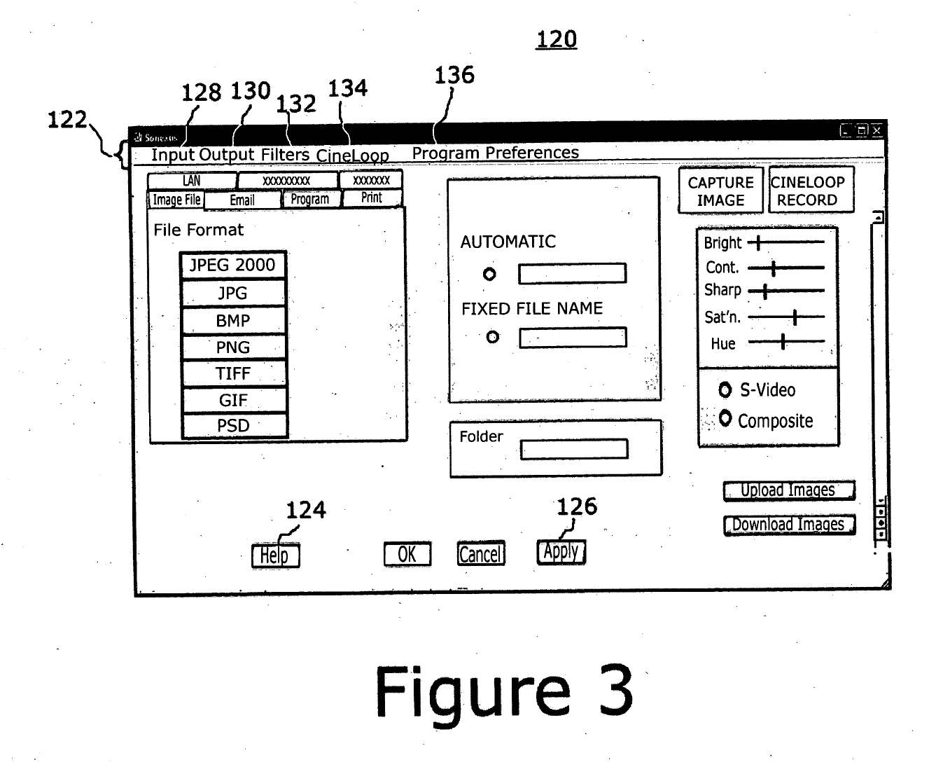

Turning now to FIG. 3, there is shown an exemplary computer display screen 120 such as might be presented to an operator of the direct video capture unit 102 previously described with reference to FIG. 2. As shown, the display 120 contains the various elements typically present in a graphical user interface, including a main menu bar 122, clickable “buttons,” (e.g., “Help” 124. “Apply” 126, etc.), and so on.

In accordance with common practice in the design of graphical user interfaces, each of the elements found in the main menu bar 122 has an associated “pull-down” menu which appears upon clicking on the corresponding menu item. One such menu item shown in FIG. 3 is the “Input” menu item 128. When selected, the Input menu preferably presents the user with a sub-menu including the following selections:
Open—opens a new window to begin a new video capture session;
Include Cursor—selects whether the cursor is to be shown in the captured image;
Properties—enables the user to select various properties, such as screen size.

Likewise, selecting the Output menu item on main menu bar 122, a sub-menu is presented including the following selections:
File—selects that the image is to be saved to a file, and to what location;
E-mail—allows the operator to email images to third parties; (must be secure)
FTP—allows for the image to be transferred via file transfer protocol (FTP); (must be secure)
VPN—permits access to the image via a virtual private network (VPN);
Properties—enables the user to select various properties such as image file format (JPEG2000, JPEG, BMP, etc.) for the output.

A Filter menu selection 132 in menu bar 122 present the user with a number of sub-menu items, including:
Brightness—allows the user to control the brightness of the image;
Contrast—allows the user to control the contrast setting for the image;
Sharpness—allows the user to control the sharpness of the image;
Saturation—allows the user to control the saturation of the image;
Hue—allows the user to control the color palette of the image.

A Cineloop item 134 in menu bar 122 presents the operator with a sub-menu including such items as:
Timer—specifies the length of a motion video segment (cineloop) to be captured;
File—specifies the file and location for saving a Cineloop;
Send—enables the operator to initiate transfer of the Cineloop;
Properties—specifies certain properties of the Cineloop, such as the number of frames per second, window size, and length of capture time.

Finally, a Program Preference menu item 134 in menu bar 122 permits the user to control certain operating preferences for the video capture process, include, for example, sounds, passwords, program window settings and user presets (user preset will let the technician program different types of exams. An example would be the fetal heart exam will have 5 cineloops 6 seconds long).

It is to be understood that the foregoing description of the graphical user interface and various components thereof is provided as an example only, and is not intended to be limiting with respect to the number and nature of menu and sub-menu selection items that may be made available to the user. Those of ordinary skill will appreciate that various other features not specified above may be implemented in order to improve the user-friendliness of the system.

Although a specific embodiment of the invention has been described herein in some detail, it is to be understood that this has been done solely for the purposes of illustrating various features and aspects of the invention, and is not intended to be limiting with respect to the scope of the invention, as defined in the claims. It is contemplated and to be understood that various substitutions, alterations, and/or modifications, including such implementation variants and options as may have been specifically noted or suggested herein, may be made to the disclosed embodiment of the invention without departing from the spirit or scope of the invention.

What is claimed is:

1. A data processing system, comprising:
at least one imaging device adapted to generate a raw video signal;
an encoder, coupled to said imaging device and adapted to receive and encode said raw video signal in accordance with a predetermined encoded protocol, thereby generating encoded graphics data having a predetermined format;
a video capture apparatus coupled to said imaging device to receive said raw video signal;
said video capture apparatus adapted to capture still frames and segments of video under control of a user and further to accept user input providing identifying information corresponding to said captured still frames and video segments;
means for delivering said still frames and segments of video along with said corresponding identifying information to an end-user;
such that said encoder is bypassed, and said end-user receives unencoded graphics data.

2. A system in accordance with claim 1, wherein said predetermined encoded protocol comprises the Digital Imaging and Communications in Medicine (DICOM) protocol.

3. A system in accordance with claim 2, wherein said encoded data is intended to be communicated to a Picture Archiving and Communications System (PACS) server.
